(19) United States
(12) Patent Application Publication
(10) Pub. No.: US 2015/0156826 A1
(43) Pub. Date: Jun. 4, 2015

(54) HIGH TEMPERATURE MICROWAVE SUSCEPTOR

(71) Applicant: NESTEC S.A., Vevey (CH)

(72) Inventor: Ulrich Johannes Erle, Cleveland, OH (US)

(21) Appl. No.: 14/412,498

(22) PCT Filed: Jun. 27, 2013
(86) PCT No.: PCT/EP2013/063480

§ 371 Date: Jan. 2, 2015

Related U.S. Application Data
(60) Provisional application No. 61/667,028, filed on Jul. 2, 2012.

(51) Int. Cl. H05B 6/64; B65D 81/34

(52) U.S. Cl. CPC H05B 6/6494; H05B 6/6482; B65D 81/3446

(57) ABSTRACT

The present invention relates to a microwave susceptor for emitting infrared energy comprising a susceptor plate comprising a non-conductive material and an electrically conductive component imparting electrical conductivity, and wherein the susceptor element has a resistance of 10 to 1000 Ohm/square, preferably 30 to 300 Ohm/square and wherein the susceptor plate is capable of withstanding a temperature above 400° C. The invention also relates to a food packaging comprising a food product and such a microwave susceptor.

### FIELD OF THE INVENTION

The present invention relates to food technology. More specifically, the present invention relates to high temperature microwave susceptors that are able to impart increased surface heating to the microwavable product.

### BACKGROUND OF THE INVENTION

Microwave susceptor materials are known in the food industry and have been used as active packaging systems within microwavable foods since the late 1970's. Susceptors are used to provide additional thermal heating on the surface of food products that are heated in a microwave oven, which helps achieve a browned, crisp surface that is desirable to the consumers.

Microwave cooking is however generally unable to deliver to a desired extend some key attributes of oven-baked food, namely browning, gratination and crisping. Today many microwaveable food products comprise a susceptor, which is essentially a metallized polyester foil, laminated to a paper or cardboard structure. In practice, these susceptors do not always deliver the desired food attributes. The main reasons are:
Insufficient contact: The heat transfer from the susceptor to the food surface is based on contact. Even a small air gap can cause a significant reduction in heat transfer, which—in addition—can lead to an overheating of the susceptor.
Insufficient electrical conductivity due to cracking: Standard susceptors tend to develop cracks during heating, especially in areas where the contact to the food is poor. This leads to reduced electrical conductivity and reduced dissipated heat.
If a susceptor loses power in areas of good food contact, it can become an obstacle to the vapour, which needs to evaporate from the food surface in order to lend crispiness to the food.

Another essential requirement for susceptors is that they have to be safe to use. In particular, the risk of overheating and a subsequent fire in the microwave oven has to be prevented. Today's standard susceptors are safe in this regard, because the effect of cracking prevents dangerously high temperatures. This is often referred to as ‘self-limitation’. However, once a susceptor has cracked, it will not regain its electrical conductivity. The self-limitation is not reversible.

Attempts have been made to provide alternative and more effective susceptors:

U.S. Pat. No. 5,410,135 (James River) disclosed a polymer material filled with electrically conductive particles. The self-limitation was achieved with the help of the thermal expansion of the polymer material. At the desired temperature limit the thermal expansion would separate the particles so much that the electrical conductivity would be insufficient for further heating. Upon cooling, the effect was reversed. The maximum temperature reachable with this kind of susceptor was 480 F. Based on the disclosed values of electrical conductivity it is considered that the dissipated heat is not sufficient, when the food itself has the ability to absorb substantial amounts of microwave energy.

In EP 0 344 574 (The Pillsbury Company) a susceptor without plastic film is disclosed. The metal is deposited directly onto a paper surface, which may be fortified with a layer of clay. This design has the advantage of being more dimensionally stable upon heating than plastic films. It is claimed that the result was a stronger heat dissipation towards the end of the cooking time. This susceptor is not available in the market today. This is considered to be due to the improved dimensional stability, there is not enough self-limitation, leading to overheating.

General Mills patent (U.S. Pat. No. 4,968,865) describes a susceptor made from a ceramic gel that has a water content between 17 and 35%. Common salt can be added in concentrations from 0.01% to 12%. This material is able to absorb substantial amounts of microwave energy, but only in its unvitrified state. This means the temperatures are limited due to the occurrence of vitrification. In the supporting graphs the maximum temperatures reached were in the area of 700 F. However, these temperatures were reached in the absence of food. As food reduces the microwave field strength in the oven, these susceptors would not reach the same temperature in the presence of food.

The susceptors according to said patent are meant to be placed underneath the food. It is apparent that direct contact rather than IR is used as a means of heat transfer from the susceptor to the food. This means that browning, gratination and crisping of irregular food surfaces cannot be achieved.

Whirlpool (U.S. 2007/0095824) disclosed a browning accessory for microwave ovens. In its preferred embodiment the microwave absorbing layer is made from rubber with ferrite inclusions. This creates a magnetic loss. The goal of self-limitation is achieved by choosing the Curie temperature for the ferrite. Once the temperature reaches a critical limit, the magnetic loss of the ferrite material will disappear, rendering it essentially microwave transparent. This mechanism is reversible. Claimed operating temperatures are 200-400° C. It is mentioned that microwave absorption could also be based on electrical conductivity, but there is no explanation how self-limitation would be achieved in this case.

There is a need for a susceptor which can better heat and brown food product when heated in a microwave oven.

The present invention seeks to address the above-described problems or provide useful alternatives. The invention also aims at other objects and particularly the solution of other problems as will appear in the rest of the present description.

### SUMMARY OF THE INVENTION

In a first aspect, a microwave susceptor for emitting infrared energy comprising a susceptor plate comprising
a non-conductive material and
an electrical conductive component imparting electrical conductivity, and
   wherein the susceptor element has a resistance of 10 to 1000 Ohm/square, preferably 30 to 300 Ohm/square, more preferably 70 to 100 Ohm/square, and wherein the susceptor plate is capable of withstanding a temperature above 400° C. Advantageously, the susceptor element has a withstanding temperature above 450° C., more preferably 550° C.

Current microwaveable food products are sometimes not as good as oven-baked ones. The main reason is the temperature distribution upon microwave baking. This invention provides a realization of oven heated quality in a microwave oven. The invention allows a transformation of a big portion of the microwave energy to surface heating of the food. In particular, it describes the infrared emitting elements used to provide surface heat to the food without direct contact.

In a second aspect, the invention relates to a microwave susceptor for emitting infrared energy comprising a susceptor plate comprising
a non-conductive material and
an magnetically active material which has a Curie temperature which is higher than the operating point temperature, and
   wherein the susceptor plate is capable of withstanding a temperature above 400° C. Advantageously, the susceptor element has a withstanding temperature above 450° C., more preferably 550° C.

In a further aspect the invention relates to a food packaging comprising a food product and a microwave susceptor as described above.

### BRIEF DESCRIPTION OF THE DRAWINGS

FIG. 1 is a schematic representation of the way the new susceptor balances the absorbed microwave power with the emitted infrared power.

FIG. 2 shows a high temperature susceptor plate suspended in a frame of thick aluminium foil.

FIG. 3 shows a product heated with a susceptor according to the invention.

FIG. 4 depicts an embodiment, in which the non-conductive plate is partially coated with an electrically conductive material.

### DETAILED DESCRIPTION

In one embodiment, the electrically conductive coating is a thin metal layer, created by a plasma or chemical vapour deposition. However, these tend to be sensitive to oxidation at high temperatures. An additional glassy layer, as commonly applied in the ceramics industry (‘glazing’), can provide oxygen protection.

In a preferred embodiment of the invention the electrically conductive coating is a coating of indium tin oxide (ITO). Other conductive coating materials, such as aluminium zinc oxide (AZO), may be used. Both coatings are less prone to oxidation than pure metal coatings, but may still require some form of protection against oxygen at high temperatures.

In another preferred embodiment, the electrically conductive layer is a DuPont glazing with a defined sheet resistance of 10 Ohm/square to 1000 Ohm/square. This product is available under the name ‘DuPont™ Q Plus™ QP60.

It is important to note that the concept of a high temperature susceptor can be realized as a packaging solution or as a microwave accessory for multiple usage. The requirements will differ regarding long term durability and price of the materials, but the same principles apply.

Although there are several different types of susceptors in use, most susceptors are aluminum metallized polyethylene terephthalate (“PET”) sheets. The PET sheets are lightly metallized with elemental aluminum and laminated onto a dimensionally stable substrate such as, for example, paper or paperboard. Indeed, standard susceptor materials have a very thin layer of metal atoms (e.g., aluminum atoms). This thin layer is typically about 20 atoms and is just thick enough to conduct electricity. Since the thickness of the layer is so small, however, and the resulting resistance is high, the currents are limited and do not cause any arcing in the microwave, as is seen with other metallic articles in the microwave. The current is sufficiently high, however, to heat the susceptor to a temperature that is high enough to provide brownness and crispness to the outside surface of a food product. As used herein, “standard microwave susceptor” or “standard susceptor” means susceptors known to the skilled artisan prior to the present disclosure, which may include, for example, the lightly metallized susceptors described above having a substrate, a thin layer of metal atoms and a polymer layer.

The development of heat energy in a susceptor placed in a microwave field is caused by the conductivity of the susceptor material. For example, a thin aluminum film with a relatively high resistance acts as the main source of heat energy. The ohmic resistance in the thin aluminum layer then leads to absorption and dissipation of microwave energy. The portion of an incident wave that is not absorbed, is partially transmitted by the susceptor material, making it available for direct volumetric heating of the food. The remaining portion of the microwave energy is reflected by the susceptor material.

This concept of standard susceptor heating works reasonably well for frozen food, which is essentially transparent to microwaves and does not absorb much microwave energy itself. As a result, relatively high electric field strength is left for the susceptor to heat up and form a crust on the surface of the food. On the other hand, the higher electrical field strength in the presence of frozen food can also be the cause of an overload situation on the susceptor. In this case, the susceptor will develop cracks rapidly and lose performance already after a short cooking time.

Non-frozen foods, however, absorb microwaves much better than frozen foods. The field strength, therefore, can be much lower, which leads to less heating effect in the susceptor material. Consequently, standard susceptor materials often show insufficient performance in combination with non-frozen foods.

The shape of the susceptor may be adapted to its particular use. For example: In cases where the food surface is larger than the area of the susceptor, the radiation from the susceptor can be distributed by making it concave, i.e. giving it the shape of a dome. It can also have a corrugated surface so that the radiation is directed sideways, at least to some degree. Another design option is to place the food in an essentially upright position and let the susceptor plates heat it by infrared radiation from both sides.

The plate support is preferably of aluminium, but other useful materials are: other metals, like tin, steel, ceramics, clay and paper with clay addition for more heat stability. In embodiments where the plate itself has a colder rim section, the support materials can be chosen freely among all packaging materials having suitable mechanic strength, such as paper, cardboard, polymers, etc.

The electrical conductivity is imparted to the susceptor by adding a conductivity component in the bulk of the susceptor material. This makes the coating unnecessary and also protects the electrically conductive component against scratching and oxidation.

For the second aspect of the invention the preferred materials are metal oxides and ferrites (having a Curie temperature higher than the operating temperature of the susceptor).

Advantageously the electrical conductivity of the susceptore of the invention is imparted to the susceptor by coating or glazing the non-conductive material with an electrically conductive layer. This provides the benefits here are that such coatings are commercially already and that the formulation of the coating may be independent of the formulation of the plate. This provides the possibility that one standard plate and several conductivities can be used. For certain designs of the susceptor ‘zoning’ may be included providing different conductivities or even non-coated areas on the same plate. This is not possible when using embedded conductive ingredient.

The electrically conductive component is selected from a group consisting of metals, semiconductors, doped metal oxides, carbon or graphite, or ionic compounds that have electrical conductivity due to ion mobility. These materials may be used as long as a certain sheet resistance in Ohm/square is achieved.

The non-conductive material is preferably selected from the group consisting of: glass (preferably Corning glass), ceramics (preferably Alumina or Wollastonite, more preferably Cordierite), plaster, clay, and salts pressed into tablets. Other temperature stable material with a minimum mechanical stability may be suitable. However, this material must not have a sheet resistance lower than what is aim for in the composite material.

The electrically conductive coating may be a thin metal layer, created by a plasma or chemical vapour deposition. It has been found that this works work well on polyester advantageously made with oxygen protection.

In a preferred embodiment of the invention, the electrically conductive coating is a coating of indium tin oxide (ITO). It has been found that this coating works particular well for repeated cooking cycles, and has good temperature stability.

A microwave susceptor according to the invention has the advantage that the mechanism of self-limitation under normal operating conditions and under abuse conditions is based on balancing the absorbed microwave power with infrared emissions.

In an additional aspect of the invention the susceptor is arranged so that a side of the susceptor which has a higher infrared emissivity oriented towards the food than the side oriented away from the food. In this embodiment the electrically conductive layer emits infrared to a lesser degree than the other side of a susceptor plate. This means a good use of the total infrared energy, as more than half reaches the food.

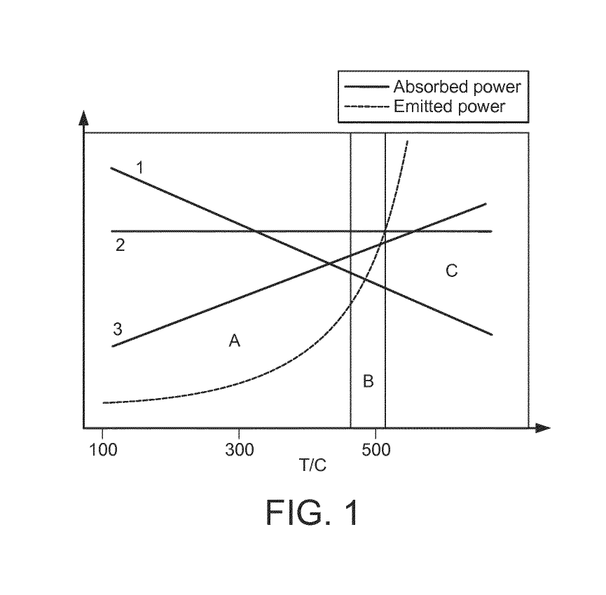

FIG. 1 is a schematic representation of the way the new susceptor balances the absorbed microwave power with the emitted infrared power. The straight lines 1, 2 and 3 represent different behaviours of the conductive layer as a function of temperature. The conductivity can decrease, increase or stay constant with rising temperature. The heat-up phase (area A) is complete and the operating area B is reached, when the susceptor emits the same infrared power that is receives in the form of microwaves. Temperatures beyond the operating point (area C) cannot be reached, because then the susceptor would emit more power than it receives.

The present invention is a novel susceptor plate, which is able to reach temperatures high enough to emit substantial amounts of infrared energy. It is self-limiting, because at very high temperatures, such as 300-550° C., there is a balance between the absorbed microwave energy and the emitted infrared energy. FIG. 1 illustrates this mechanism:

As mentioned above, in curve 1, the absorbed microwave power is negatively correlated to the temperature of the plate. In case the electrical conductivity shows no temperature dependence curve 2), the principle of self-stabilization remains the same. This mechanism also applies in the case of curve 3, which shows a positive correlation between temperature and absorbed microwave power. Without wishing to be bound by theory, it is believed this relies on the well-established law of Stefan and Boltzmann, according to which the infrared emissions of any material are a strong function of temperature.

It is not possible that the plate reaches a higher temperature than the operating point. Due to the choice of materials and the way the plate is suspended in the packaging or in a microwave accessory, it does not cause heat damage to its surroundings.

In one embodiment the plate is a corning glass plate, coated with Indium Tin Oxide (ITO) to give a sheet resistance of 70-100 Ohm/square. The plate is suspended in a lid made of strong aluminium foil. The melting point of aluminium is approx. 660° C. This temperature was not reached in any of the trials.

In another embodiment, the plate is a ceramic (Cordierite) plate with an electrically conductive glaze. In this case it is easily possible to leave a certain portion of the rim unglazed so that the heating effect occurs only in the centre. Due to limited heat conductivity as well as convective and radiative losses, the temperature at the outer rim, where the plate is suspended, can be low enough to use a polymer or paper-based material at the contact points. This makes aluminium unnecessary at the contact points. A similar effect can be reached, if the rim section is coated or glazed by a material that is a very good electrical conductor, i.e. a better conductor than the heat dissipating section. In this case, the rim is also much colder than the centre of the plate, but the food is more shielded from the microwave. This raises the electrical field in the oven and shifts the balance more towards surface heating versus volumetric microwave heating.

It is preferred that the magnetically active material comprises ferrites or metal oxides. This provides the benefit of sufficiently strong magnetic losses and relatively low material costs.

The invention is further described with reference to the following examples. It will be appreciated that the invention as claimed is not intended to be limited in any way by these examples.”

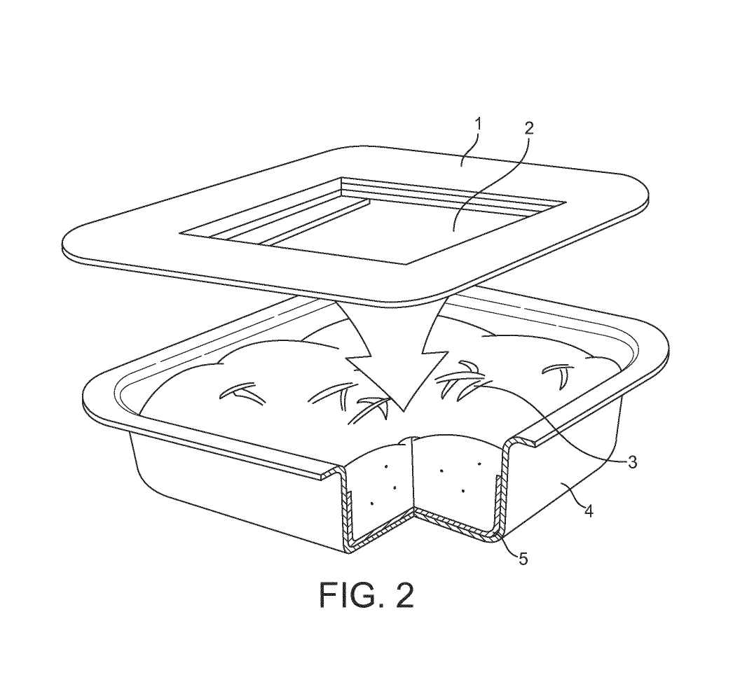

FIG. 2 shows a high temperature susceptor plate suspended in a frame of thick aluminium foil. The susceptor is placed at a suitable distance to the food surface. The aluminium frame typically rests on another packaging material.
1—susceptor plate
2—aluminium frame
3—lasagna
4—tray
5—aluminium shielding in tray

FIG. 2 shows the corning glass susceptor embedded in an aluminium lid, placed over a lasagna tray at a distance of approx. 0.75 inches.

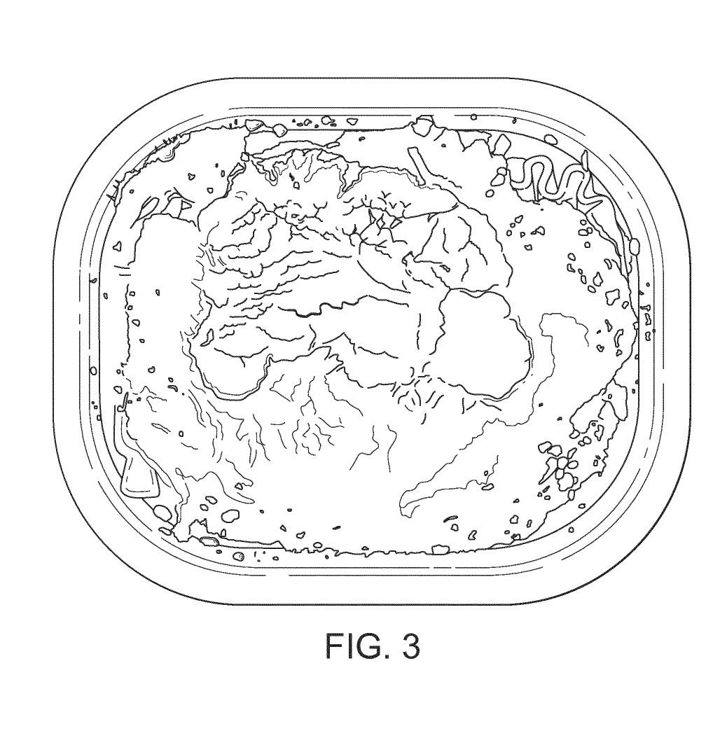

The susceptor of this invention is designed to transfer heat to the food by means of infrared radiation. This means that it will normally be placed at a distance from the food that enables water vapour to leave the food surface. Irregular food surfaces are browned better than with standard susceptors, because no direct contact is needed. Sticky food surfaces, such as cheese layers, can be browned and gratinated without problems. FIG. 3 shows the surface of a lasagna after microwaving according to the instructions.

The browning effect in this example is very strong, but too localized. This can be changed in principle by increasing the distance between food and susceptor or by making the susceptor emit radiation in a more diffuse way. The latter effect can be achieved by surface roughening and other means.

FIG. 3 shows a single serve STOUFFER'S™ Vegetable Lasagna, prepared according to the normal instructions (11:30 min at 50% power in a 900 Watt oven). The tray used was partially shielded.

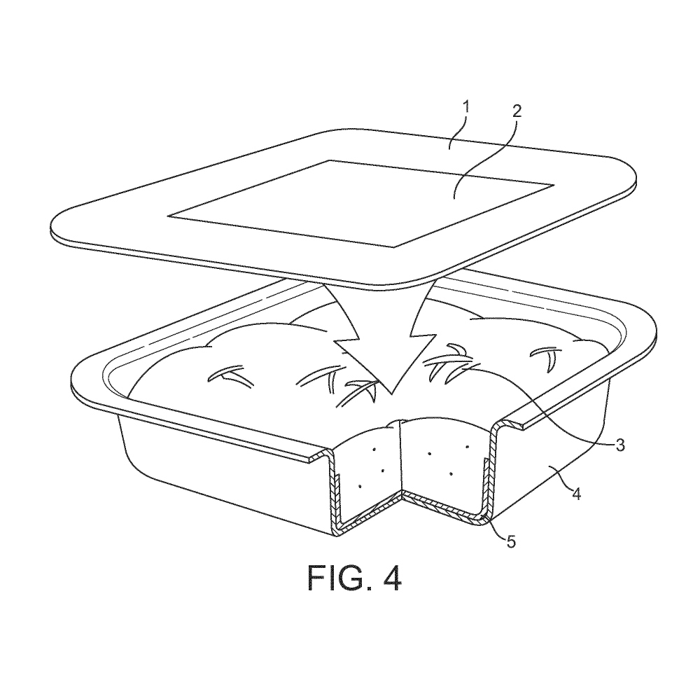

In FIG. 4 another embodiment of the invention is depicted. Here the non-conductive plate is partially coated with an electrically conductive material. This portion of the plate reaches operating temperature, whereas the rim section is much colder. The plate typically rests on another packaging material with the outer, non-coated parts.
1—coated area
2—non-coated area
3—lasagna
4—tray
5—aluminium shielding in tray

Another aspect of infrared browning is the emission spectrum of the high temperature susceptor. The browning effect also depends on the overall packaging. It is one subject of this invention that the new susceptor can be combined with a food package that is more reflective for microwaves than it is transmissive.

This concept was already described in U.S. patent application ‘Highly Conductive Microwave Susceptors’ U.S. Ser. No. 13/149,534 the description of which is hereby included by reference. It is based on the fact that there is a competition for microwave energy between the food and the microwave active packaging. A standard lasagna tray may transmit so much microwave energy that the remaining field strength does not allow the susceptor to absorb enough energy for browning and crisping. This problem is solved in the present invention by using a lasagna tray which is partially shielded from microwaves by an aluminium pattern. If the susceptor plate also has a sheet resistance below 188.5 Ohm/square and is combined with the aforementioned aluminium lid, this design falls under the description in ‘Highly Conductive Microwave Susceptors’.

1. A microwave susceptor for emitting infrared energy comprising a susceptor plate comprising:
a non-conductive material;
an electrically conductive component imparting electrical conductivity; and
the susceptor element has a resistance of 10 to 1000 Ohm/square, preferably 30 to 300 Ohm/square, and the susceptor plate is capable of withstanding a temperature above 400° C.

2. A microwave susceptor for emitting infrared energy comprising a susceptor plate comprising:
a non-conductive material;
a magnetically active material which has a Curie temperature which is greater than the operating point temperature; and
the susceptor plate is capable of withstanding a temperature above 400° C.

3. A microwave susceptor according to claim 1, wherein the susceptor is capable of emitting infrared radiation above 50% based on black body radiation.

4. A microwave susceptor according to claim 1, wherein the susceptor comprises a plate support having a melting point above 600° C.

5. A microwave susceptor according to claims 1, wherein the plate support is made of aluminium.

6. A microwave susceptor according to claim 1, wherein the electrical conductivity is imparted to the susceptor by adding a conductivity component in the bulk of the susceptor material.

7. A microwave susceptor according to claim 1, wherein the electrical conductivity is imparted to the susceptor by coating or glazing the non-conductive material with an electrically conductive layer.

8. A microwave susceptor according to claim 1, wherein the electrically conductive component is selected from the group consisting of metals, semiconductors, doped metal oxides, carbon or graphite, and ionic compounds that have electrical conductivity due to ion mobility.

9. A microwave susceptor according to claim 1, wherein the non-conductive material is selected from the group consisting of: corning glass, ceramics, plaster, clay, and salts pressed into tablets.

10. A microwave susceptor according to claim 1, wherein the electrically conductive coating is thin metal layers, created by a plasma or chemical vapour deposition.

11. A microwave susceptor according to claim 1, wherein the electrically conductive coating is a coating of indium tin oxide (ITO).

12. A microwave susceptor according to claim 1, wherein the mechanism of self-limitation is based on the balancing the absorbed microwave power with infrared emissions.

13. A food packaging comprising a food product and a microwave susceptor comprising:
a non-conductive material;
an electrically conductive component imparting electrical conductivity; and
the susceptor element has a resistance of 10 to 1000 Ohm/square, preferably 30 to 300 Ohm/square, and the susceptor plate is capable of withstanding a temperature above 400° C.

14. A microwave susceptor according to claim 2, wherein the susceptor is capable of emitting infrared radiation above 50% based on black body radiation.

15. A microwave susceptor according to claim 2, wherein the susceptor comprises a plate support having a melting point above 600° C.

16. A microwave susceptor according to claim 2, wherein the plate support is made of aluminium.

17. A microwave susceptor according to claim 2, wherein the electrical conductivity is imparted to the susceptor by adding a conductivity component in the bulk of the susceptor material.

18. A microwave susceptor according to claim 2, wherein the electrical conductivity is imparted to the susceptor by coating or glazing the non-conductive material with an electrically conductive layer.

19. A microwave susceptor according to claim 2, wherein the electrically conductive component is selected from the group consisting of metals, semiconductors, doped metal oxides, carbon or graphite, and ionic compounds that have electrical conductivity due to ion mobility.

20. A microwave susceptor according to claim 2, wherein the non-conductive material is selected from the group consisting of: corning glass, ceramics, plaster, clay, and salts pressed into tablets.

21. A microwave susceptor according to claim 2, wherein the electrically conductive coating is thin metal layers, created by a plasma or chemical vapour deposition.

22. A microwave susceptor according to claim 2, wherein the electrically conductive coating is a coating of indium tin oxide (ITO).

23. A microwave susceptor according to claim 2, wherein the mechanism of self-limitation is based on the balancing the absorbed microwave power with infrared emissions.

24. A food packaging comprising a food product and a microwave susceptor comprising:
a non-conductive material;
a magnetically active material which has a Curie temperature which is greater than the operating point temperature; and
the susceptor plate is capable of withstanding a temperature above 400° C.
